(19) United States
(12) Patent Application Publication
(10) Pub. No.: US 2004/0041532 A1
(43) Pub. Date: Mar. 4, 2004

(54) Control circuit of a fan having an accessory lamp

(76) Inventor: Cheng-Fu Cheng, Feng Yuan (TW)

Correspondence Address: CHARLES E. BAXLEY, ESQUIRE, Hart, Baxley, Daniels & Holton, 59 John St, 5 FL, New York, NY, 10038, US

(21) Appl. No.: 10/233,241

(22) Filed: Sep. 3, 2002

(51) Int. Cl. H02P 1/04

(52) U.S. Cl. 318/471

(57) ABSTRACT

A control circuit of a fan having an accessory lamp includes a lamp, a lamp circuit, a fan motor, a fan circuit, and a capacitor. The capacitor is mounted between the lamp and the fan motor. By using the relationship of the impedance of the capacitor, the lamp and the fan motor, operation of the lamp may start the fan motor automatically, and operation of the fan motor will not start the lamp.

### BACKGROUND OF THE INVENTION

1. Field of the Invention

The present invention relates to a control circuit of a fan having an accessory lamp, and more particularly to a control circuit of a fan having an accessory lamp, wherein the fan of the present invention has a simplified construction, has a lower cost of fabrication, and the lamp will not be overheated.

2. Description of the Related Art

A first conventional fan having an accessory lamp in accordance with the prior art shown in FIG. 1 comprises a lamp 10A, a lamp circuit 11A, a fan motor 12A, a fan circuit 13A, and a housing 14A. The lamp circuit 11A and the fan circuit 13A are connected to an electric power respectively. The lamp circuit 11A is provided with a switch S1′ for controlling the lamp 10A, and the fan circuit 13A is provided with a switch S2′ for controlling the fan motor 12A.

However, the first conventional fan has the following disadvantages.

1. When the lamp 10A is used during a long-term, it produces much heat, thereby greatly increasing the temperature in the housing 14A, so that the housing 14A and the parts contained in the housing 14A are easily worn out or burned.

2. The lamp 10A is constantly maintained at a high temperature state, thereby greatly shortening the lifetime of the lamp 10A.

A second conventional fan having an accessory lamp in accordance with the prior art shown in FIGS. 2 and 3 comprises a lamp 10B, a lamp circuit 11B, a fan motor 12B, a fan circuit 13B, and a housing 14B. The lamp circuit 11B and the fan circuit 13B are connected to an electric power respectively. The lamp circuit 11B is provided with a switch S1″ for controlling the lamp 10B, and the fan circuit 13B is provided with a switch S2″ for controlling the fan motor 12B. A heat sensor 16B is mounted between the lamp circuit 11B and the fan circuit 13B. The heat sensor 16B detects the high temperature of the lamp 10B, and may start the fan motor 12B automatically, so that the lamp 10B may be cooled by the fan motor 12B.

However, the second conventional fan has the following disadvantages.

1. The heat sensor 16B is expensive, thereby increasing the cost of fabrication.

2. The precision of detection of the heat sensor 16B is affected when the room temperature reaches a very high value.

3. The heat sensor 16B opens and closes the fan motor 12B according to the temperature values. When the temperature of the lamp 10B is slightly smaller than the sensing temperature, the heat sensor 16B closes the fan motor 12B, so that the temperature of the lamp 10B is increased. At this time, the heat sensor 16B opens the fan motor 12B again. Thus, the fan motor 12B is opened and closed intermittently, thereby greatly shortening the lifetime of the fan motor 12B.

4. The fan motor 12B is opened and closed intermittently, thereby producing noise.

### SUMMARY OF THE INVENTION

The present invention has arisen to mitigate and/or obviate the disadvantage of the conventional fan having an accessory lamp.

The primary objective of the present invention is to provide a control circuit of a fan having an accessory lamp, wherein when the lamp is lighted, the fan motor may also be simultaneously operated to drive the fan to operate slowly, so as to cool the lamp and the parts contained in the housing, thereby preventing the lamp and the parts from being worn out due to overheat, and thereby increasing the lifetime of the lamp and the parts contained in the housing.

Another objective of the present invention is to provide a control circuit of a fan having an accessory lamp, wherein the fan motor will not be closed and opened continuously and intermittently, thereby increasing the lifetime of the fan motor.

A further objective of the present invention is to provide a control circuit of a fan having an accessory lamp, wherein the capacitor has a cheaper price, thereby reducing the cost of fabrication.

A further objective of the present invention is to provide a control circuit of a fan having an accessory lamp, wherein the lamp will not be overheated.

In accordance with the present invention, there is provided a control circuit of a fan having an accessory lamp, comprising a lamp, a lamp circuit, a fan motor, a fan circuit, and a capacitor, wherein:

the lamp circuit has a first end connected to an electric power and a second end connected to the ground;

the lamp is located on the lamp circuit;

the fan circuit has a first end connected to the electric power and a second end connected to the ground;

the fan motor is located on the fan circuit; and

the capacitor is mounted between the lamp and the fan motor.

Further benefits and advantages of the present invention will become apparent after a careful reading of the detailed description with appropriate reference to the accompanying drawings.

### BRIEF DESCRIPTION OF THE DRAWINGS

FIG. 1 is a circuit diagram of a first conventional control circuit of a fan having an accessory lamp in accordance with the prior art;

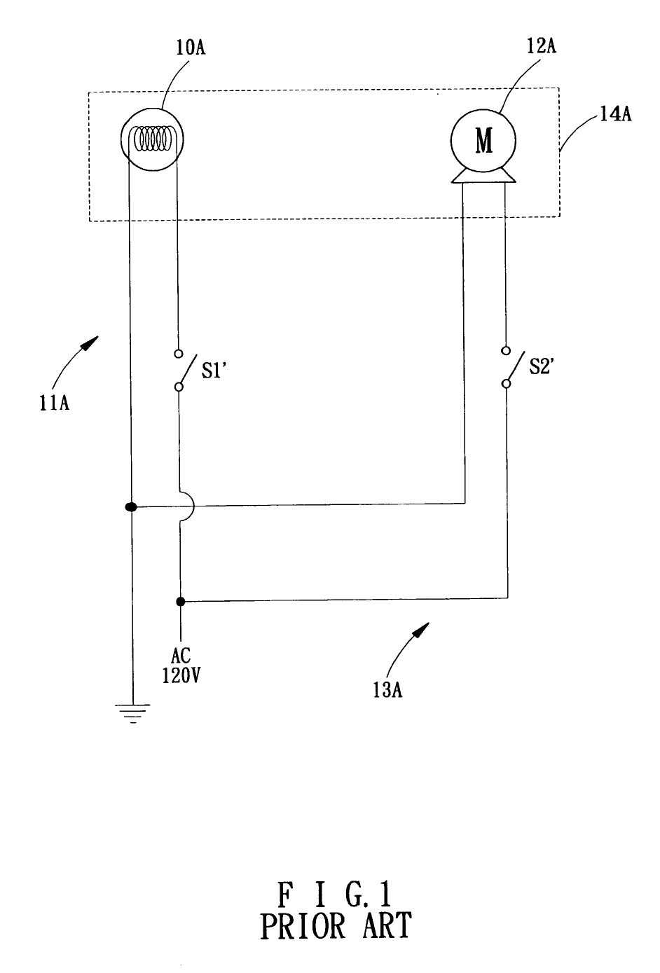

FIG. 2 is a schematic structural view of a second conventional control circuit of a fan having an accessory lamp in accordance with the prior art;

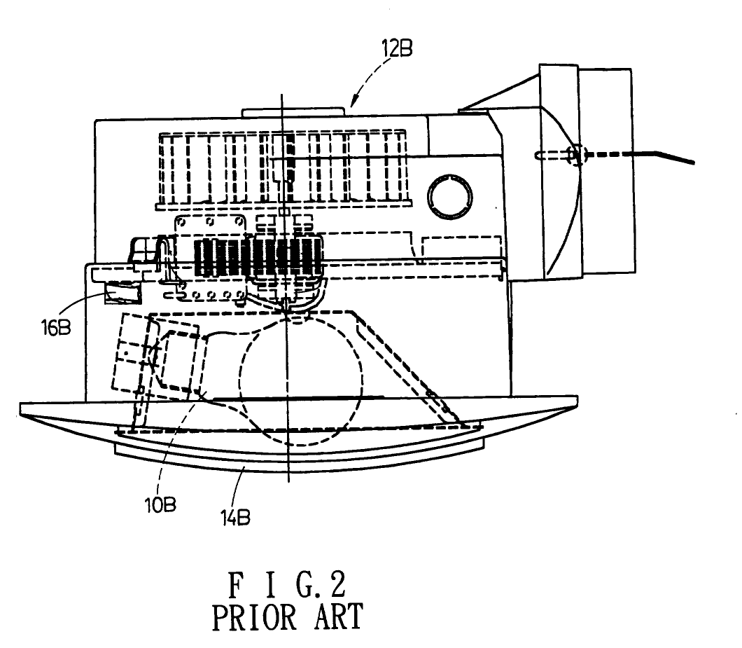

FIG. 3 is a circuit diagram of the second conventional control circuit of a fan having an accessory lamp in accordance with the prior art;

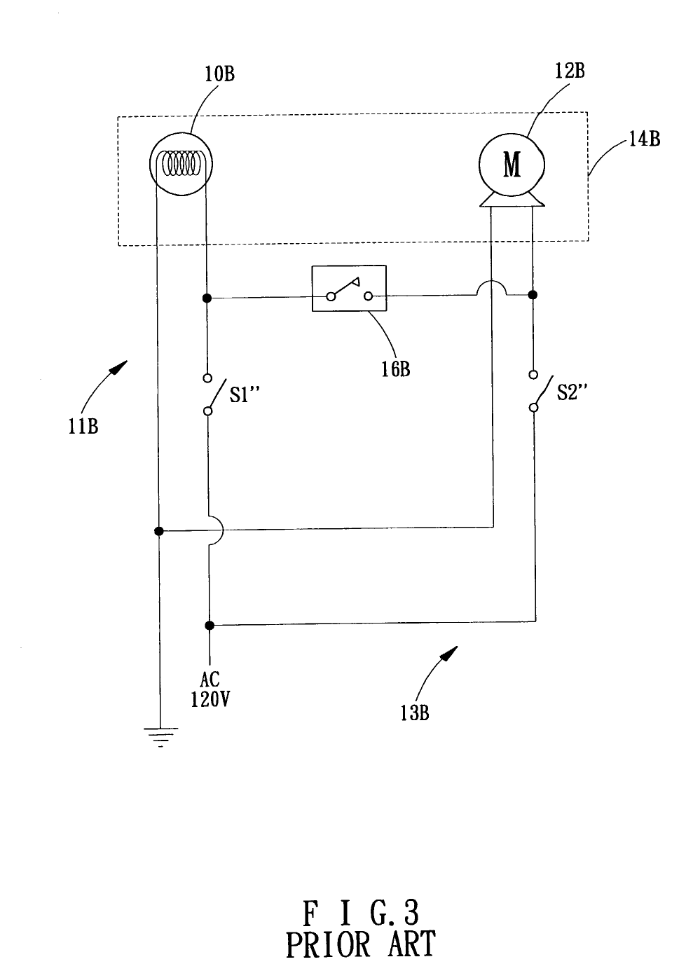

FIG. 4 is a circuit diagram of a control circuit of a fan having an accessory lamp in accordance with a preferred embodiment of the present invention;

FIG. 5 is a schematic operational view of the control circuit of a fan having an accessory lamp as shown in FIG. 4 in use;

FIG. 6 is a schematic operational view of the control circuit of a fan having an accessory lamp as shown in FIG. 4 in use; and

FIG. 7 is a reference table of experimental data of the control circuit of a fan having an accessory lamp in accordance with the preferred embodiment of the present invention.

### DETAILED DESCRIPTION OF THE INVENTION

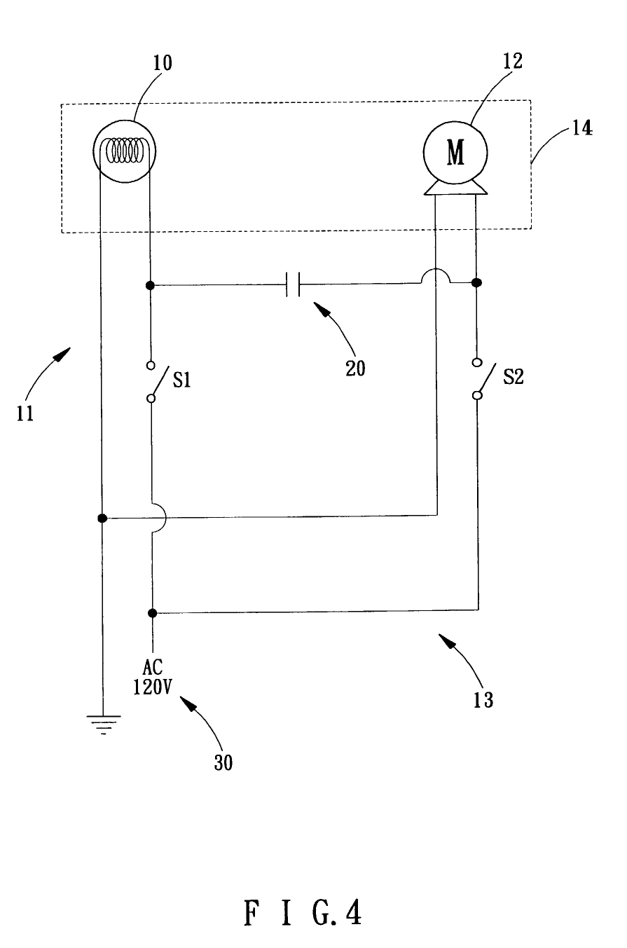

Referring to the drawings and initially to FIG. 4, a control circuit of a fan having an accessory lamp in accordance with a preferred embodiment of the present invention comprises a lamp 10, a lamp circuit 11, a fan motor 12, a fan circuit 13, a housing 14, and a capacitor 20.

The lamp 10 is mounted in the housing 14.

The lamp circuit 11 has a first end connected to an electric power 30 and a second end connected to the ground. The lamp 10 is located on the lamp circuit 11. The lamp circuit 11 is provided with a first switch S1 located adjacent to the electric power 30 for controlling the lamp 10.

The fan motor 12 is mounted in the housing 14.

The fan circuit 13 has a first end connected to the electric power 30 and a second end connected to the ground. The fan motor 12 is located on the fan circuit 13. The fan circuit 13 is provided with a second switch S2 located adjacent to the electric power 30 for controlling the fan motor 12.

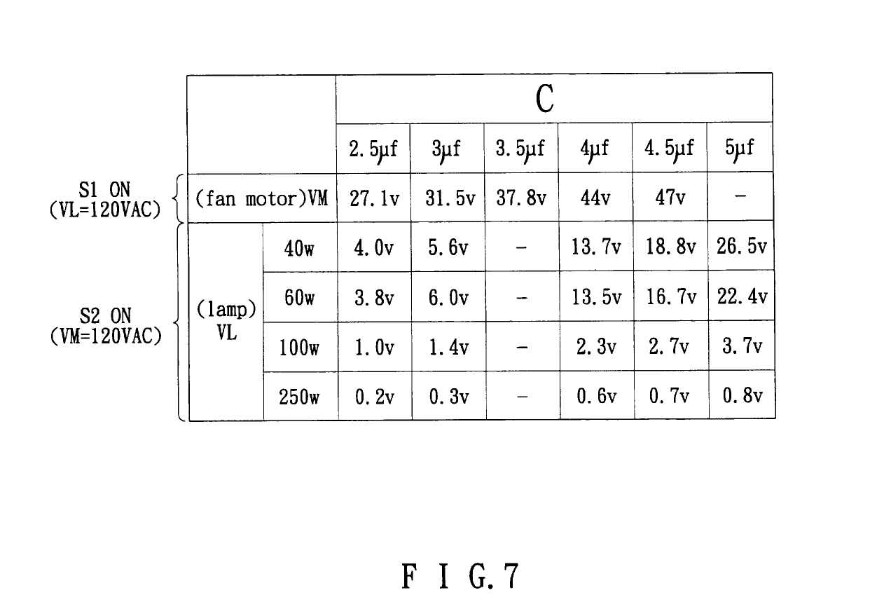

The capacitor 20 has a predetermined impedance as shown FIG. 7. The capacitor 20 is mounted between the lamp 10 and the fan motor 12. Preferably, the capacitor 20 has a first end connected to the first end of the lamp circuit 11 and located between the lamp 10 and the electric power 30, and has a second end connected to the first end of the fan circuit 13 and located between the fan motor 12 and the electric power 30. Preferably, the first end of the capacitor 20 is located between the first switch S1 and the lamp 10, and the second end of the capacitor 20 is located between the second switch S2 and the fan motor 12.

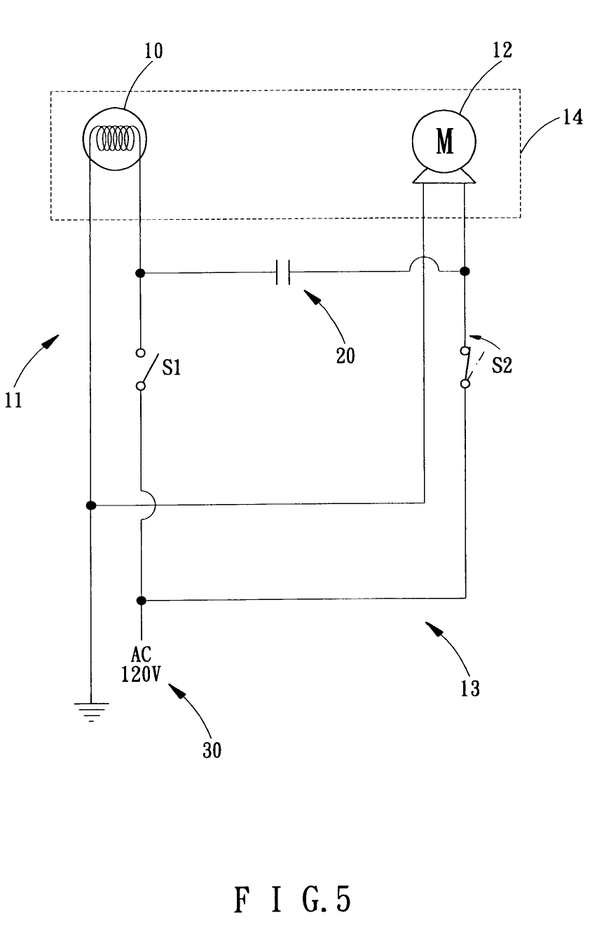

Referring to FIGS. 5 and 7, when the second switch S2 of the fan circuit 13 is pressed, the fan circuit 13 is connected to the electric power 30, thereby forming a closed loop, so that the fan motor 12 may drive the fan to rotate. At this time, the capacitor 20 is connected to the lamp 10 in a serial manner, and the capacitor 20 together with the lamp 10 is connected to the fan motor 12 in a parallel manner. The lamp 10 has an impedance mush smaller than that of the capacitor 20, so that the voltage of the lamp 10 may be neglected, and most of the voltage is located on the two ends of the capacitor 20. In such a manner, the current will not pass through the lamp 10, so that the lamp 10 will not be lighted. Thus, when the second switch S2 of the fan circuit 13 is pressed, the fan motor 12 may be operated individually, and the lamp 10 will not be lighted.

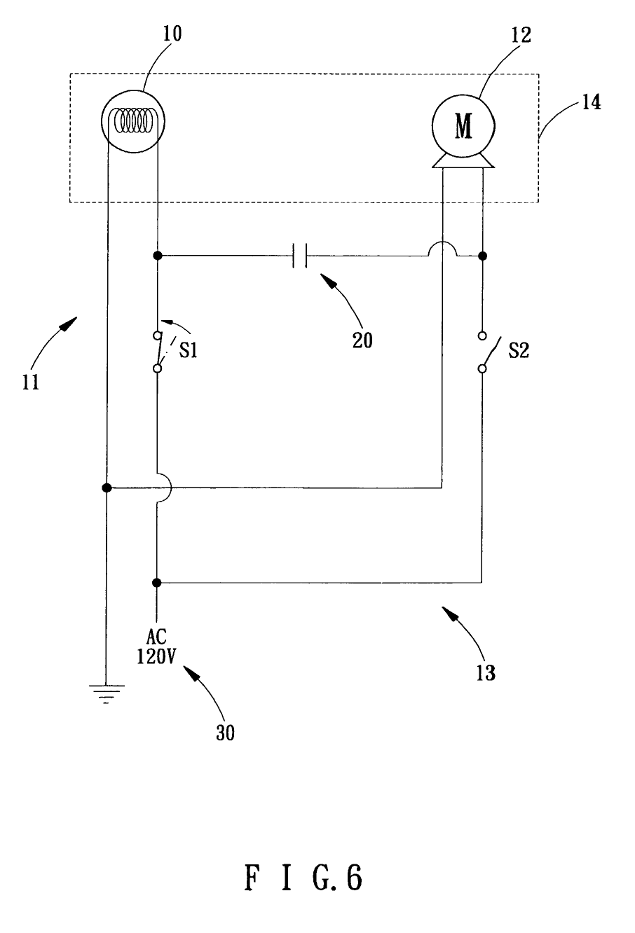

Referring to FIGS. 6 and 7, when the first switch S1 of the lamp circuit 11 is pressed, the lamp circuit 11 is connected to the electric power 30, thereby forming a closed loop, so that the lamp 10 may be lighted immediately. At this time, the capacitor 20 is connected to the fan motor 12 in a serial manner, and the capacitor 20 together with the fan motor 12 is connected to the lamp 10 in a parallel manner. Thus, the capacitor 20 an the fan motor 12 may form a serial loop, and the fan motor 12 may form an inductive load. In such a manner, the impedance of the fan motor 12 cannot be neglected, so that the voltage of the fan motor 12 cannot be neglected. Thus, the voltage is distributed on the capacitor 20 and the fan motor 12, so that the current may pass through the fan motor 12, thereby starting and operating the fan motor 12 through the capacitor 20. Thus, when the first switch S1 of the lamp circuit 11 is pressed, the lamp 10 may be lighted and the fan motor 12 may also be operated.

Accordingly, when the lamp 10 is lighted, the fan motor 12 may also be simultaneously operated to drive the fan to operate slowly, so as to cool the lamp 10 and the parts contained in the housing 14, thereby preventing the lamp 10 and the parts from being worn out due to overheat, and thereby increasing the lifetime of the lamp 10 and the parts contained in the housing 14. In addition, the fan motor 12 will not be closed and opened continuously and intermittently, thereby increasing the lifetime of the fan motor 12. Further, the capacitor 20 has a price mush smaller than that of the heat sensor as disclosed in the prior art, thereby reducing the cost of fabrication. Further, the lamp 10 will not be overheated. Further, the fan motor 12 may drive the fan to operate slowly, so as to cool the lamp 10 and the parts contained in the housing 14, thereby preventing from incurring noise during the cooling process.

As shown in FIG. 7, when the capacitance of the capacitor 20 is equal to 4 μf, and the power of the lamp 10 and the fan is equal to 100W, the lamp 10 will consume a voltage equal to 2.3V, and the voltage of the fan motor 12 is equal to 44V. On the other hand, when the capacitance of the capacitor 20 is equal to 4.5 μf, and the power of the lamp 10 and the fan is equal to 250W, the lamp 10 will consume a voltage equal to 0.7V, and the voltage of the fan motor 12 is equal to 47V. Preferably, the optimum capacitance of the capacitor 20 is ranged between 4 μf and 5 μf, and the optimum power of the lamp 10 is ranged between 40W and 250W.

Accordingly, in the control circuit of a fan having an accessory lamp in accordance with the present invention, the capacitor 20 is mounted between the lamp 10 and the fan motor 12. By using the relationship of the impedance of the capacitor 20, the lamp 10 and the fan motor 12, operation of the lamp 10 may start the fan motor 12 automatically, and operation of the fan motor 12 will not start the lamp 10.

While the preferred embodiment(s) of the present invention has been shown and described, it will be apparent to those skilled in the art that various modifications may be made in the embodiment without departing from the spirit of the present invention. Such modifications are all within the scope of the present invention.

What is claimed is:

1. A control circuit of a fan having an accessory lamp, comprising a lamp, a lamp circuit, a fan motor, a fan circuit, and a capacitor, wherein:
the lamp circuit has a first end connected to an electric power and a second end connected to the ground;
the lamp is located on the lamp circuit;
the fan circuit has a first end connected to the electric power and a second end connected to the ground;
the fan motor is located on the fan circuit; and
the capacitor is mounted between the lamp and the fan motor.

2. The control circuit of a fan having an accessory lamp in accordance with claim 1, wherein the capacitor has a first end connected to the first end of the lamp circuit and located between the lamp and the electric power, and has a second end connected to the first end of the fan circuit and located between the fan motor and the electric power.

3. The control circuit of a fan having an accessory lamp in accordance with claim 1, wherein the lamp circuit is provided with a first switch located adjacent to the electric power, the fan circuit is provided with a second switch located adjacent to the electric power, and the first end of the capacitor is located between the first switch and the lamp, and the second end of the capacitor is located between the second switch and the fan motor.

4. The control circuit of a fan having an accessory lamp in accordance with claim 1, wherein the capacitor has a capacitance ranged between 1.5 μf and 5 μf, and the lamp has a power ranged between 40W and 250W.

5. The control circuit of a fan having an accessory lamp in accordance with claim 1, wherein the capacitor has an optimum capacitance ranged between 4 μf and 5 μf, and the lamp has an optimum power ranged between 40W and 250W.
